(19) United States
(12) Patent Application Publication
(10) Pub. No.: US 2017/0200141 A1
(43) Pub. Date: Jul. 13, 2017

(54) METHODS AND SYSTEMS FOR MANAGING ELECTRONIC CONTENTS IN ELECTRONIC PUBLICATION

(71) Applicant: GLOSSAREAD TECHNOLOGIES PRIVATE LIMITED, New Delhi (IN)

(72) Inventor: Chandrabhanu Pattajoshi, Gurgaon (IN)

(21) Appl. No.: 15/250,769

(22) Filed: Aug. 29, 2016

(30) Foreign Application Priority Data
Jan. 13, 2016 (IN) 201611001277

(51) Int. Cl. G06Q 20/12; G06F 17/30

(52) U.S. Cl. CPC G06Q 20/123; G06F 17/3089

(57) ABSTRACT

A method and a system for managing electronic contents in electronic publications are provided. The method extracts profile information of a user from one or more databases based on login account information received from the user to access an electronic publication. The electronic publication includes a plurality of micro-contents. The method further arranges the plurality of micro-contents in the electronic publication dynamically based on the extracted profile information of the user. The method then identifies cost for accessing each of the plurality of micro-contents based on a predefined criteria. Thereafter, the method receives a request from the user to access one or more micro-contents from the plurality of micro-contents. Moreover, the method allows the user to access the one or more micro-contents post payment of the cost for accessing the one or more micro-contents.

### CROSS-REFERENCE TO RELATED APPLICATION

This application claims benefit of India patent application no. 201611001277, filed on Jan. 13, 2016, the disclosure of which is hereby incorporated by reference in its entirety for all purposes.

### FIELD OF THE INVENTION

The present invention relates to digital publications and, more particularly, to a method and system for managing electronic contents in electronic publications.

### BACKGROUND

Today, with an increase in the usage of Internet, innumerous electronic publications are available over the Internet for users. Each electronic publication will cover articles that include a wide range of interest, varying from current affairs to sports, politics to fashion and paid advertisements to free advertisements as they are intended to be read by different users of different interests at various geographies. These electronic publications are financed majorly by advertising contained within them and to an extent also from the subscription cost received by its users. Hence, users are often presented with clutters of advertisements while accessing articles associated with the electronic publications, which is quite frustrating for the users.

Further, it is also not easy for all the users to instantaneously access articles of their interest. This is because the articles are published or listed in the electronic publication based on either editor/publisher choice and/or advertisements fetched by the articles. Thus, for some users the articles of their choice may be positioned or posted at a location for which they have to move across multiple tabs and/or read through one or more advertisements to locate those articles. Hence, the listing of articles in the electronic publications also adds to frustration of users because of which they tend to avoid subscribing these publications.

In addition to the above drawbacks, typically the users also need to subscribe the entire electronic publication, even if only a limited number of contents from the electronic publications are of interest to the users. Thus, it is neither cost-effective nor time efficient for most of the users to subscribe many of these electronic publications. Hence, some users may avoid subscribing to these electronic publications, despite being interested in at least some of the portions of the electronic publications. Therefore, there is a need for effective management of the electronic contents in electronic publications for precluding the advertisement therein and providing cost-effective subscription of the electronic publications to the users.

### SUMMARY

Various methods, systems and computer readable mediums for managing electronic contents in electronic publications are disclosed. In an embodiment, a method for managing electronic contents in electronic publications is provided. The method includes extracting profile information of a user from one or more databases based on login account information received from the user to access an electronic publication. The electronic publication includes a plurality of micro-contents. The method then dynamically arranges the plurality of micro-contents in the electronic publication based on the extracted profile information of the user. Thereafter, the method identifies cost for accessing each of the plurality of micro-contents based on a predefined criteria. Further, the method receives a request from the user to access one or more micro-contents from the plurality of micro-contents. The method then allows the user to access the one or more micro-contents post payment of the cost for accessing the one or more micro-contents.

In another embodiment, a system for managing electronic contents in electronic publications is provided. The system comprises a memory to store a plurality of micro-contents. The system further comprises a communication interface configured to receive web requests from a user for providing accesses to at least one micro-content from the plurality of micro-contents. The system also includes a processor communicably coupled with the memory and the communication interface to fetch information and instructions from the memory. The processor is configured to extract profile information of the user from one or more databases based on login account information received from the user to access the electronic publication. The processor is further configured to dynamically arrange the plurality of micro-contents in the electronic publication based on the extracted profile information of the user. The processor then identifies cost for accessing each of the plurality of micro-contents based on a predefined criteria. The processor is further configured to receive a request from an input device of the user to access one or more micro-contents from the plurality of micro-contents. The processor then allows the user to access the one or more micro-contents post payment of the cost for accessing the one or more micro-contents.

In yet another embodiment, a non-transitory, computer-readable storage medium storing computer-executable program instructions for managing electronic contents in electronic publications is provided. The computer-executable program instructions implements extracting profile information of a user from one or more databases based on login account information received from the user to access an electronic publication. The computer-executable program instructions then dynamically arrange the plurality of micro-contents in the electronic publication based on the extracted profile information of the user. Thereafter, the computer-executable program instructions identify cost for accessing each of the plurality of micro-contents based on a predefined criteria. Further, the computer-executable program instructions receive a request from the user to access one or more micro-contents from the plurality of micro-contents. The computer-executable program instruction then allows the user to access the one or more micro-contents post payment of the cost for accessing the one or more micro-contents.

Other aspects and example embodiments are provided in the drawings and the detailed description that follows.

### BRIEF DESCRIPTION OF THE DRAWINGS

For a more complete understanding of example embodiments of the present technology, reference is now made to the following descriptions taken in connection with the accompanying drawings in which:

FIG. 1 illustrates an example representation of an environment, where various embodiments of the present disclosure may be practiced;

FIG. 2 is a flow chart showing a method to manage micro-contents in an electronic publication, in accordance with an embodiment of the present disclosure;

FIG. 3 illustrates an exemplary depiction of a user login page on an electronic publication portal, in accordance with an example embodiment;

FIG. 4 illustrates an exemplary depiction of dynamically arranged cover page for multiple users, in accordance with an example embodiment;

FIG. 5 illustrates an exemplary template for presenting the micro-contents to users, in accordance with an example embodiment;

FIG. 6 illustrates an exemplary template for presenting a selected micro-content and a total cost associated with the selected micro-content, in accordance with an example embodiment;

FIG. 7 illustrates an exemplary method for determining cost of micro-contents, in accordance with an example embodiment;

FIG. 8 illustrates a block diagram that illustrates a system, in accordance with an embodiment of the present disclosure; and

FIG. 9 illustrates a flow diagram depicting a method to manage micro-contents in electronic publications, in accordance with another example embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term ‘micro-content’ used throughout the description includes any digital or electronic article which is uploaded on the Internet. Further, the terms ‘users’ and ‘subscribers’ are used interchangeably. The term electronic publication corresponds to digital magazines, electronic books and collection of electronic documents. The ‘micro-content’ used throughout the description can relate to any piece of standalone article or a small part of the electronic publication such as a chapter. Further, unless specified otherwise, micro-contents used throughout the present disclosure are paid contents and the micro-contents are only available for access to users by way of payments made via one or more available payment options for accessing the micro-contents.

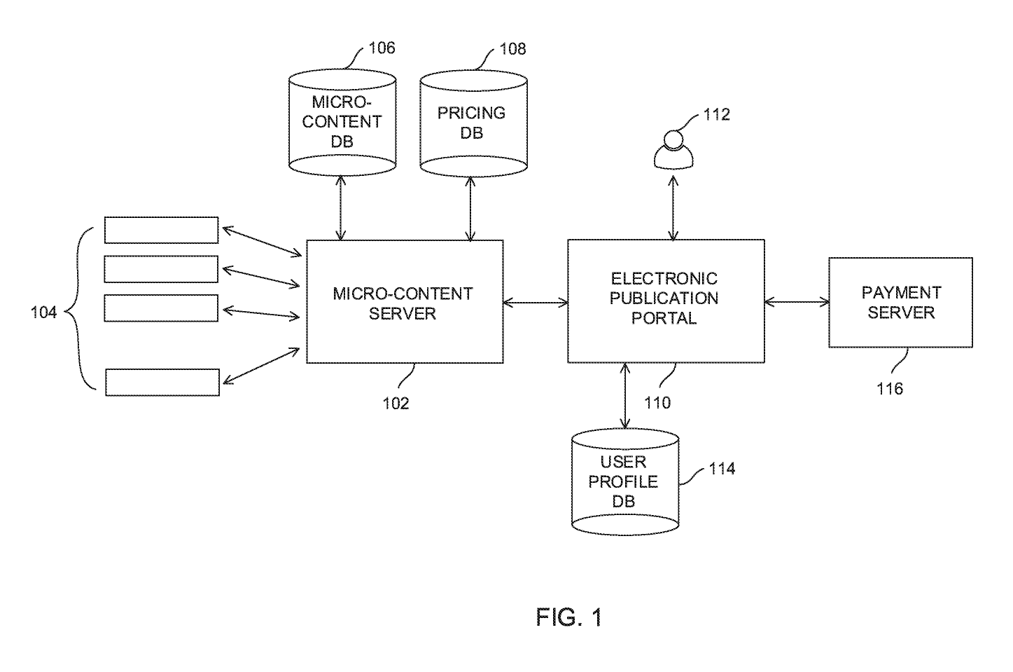

Without loss of generality, FIG. 1 shows an example representation of an environment, where one or more embodiments of the present invention can be implemented. A micro-content server 102 receives one or more electronic publications, where each electronic publication may include a plurality of micro-contents 104 (hereinafter referred as ‘the micro-contents 104’), and the micro-content server 102 is configured to store the one or more electronic publications in forms of the micro-contents 104 in a micro-content database 106. In an embodiment, the micro-content server 102 is a computer, or any unified or distributed system that process the request of storage, retrieval or other data processing functions related to the micro-contents 104. Examples of the micro-contents 104 include, but are not limited to one or more of different articles including similar or different contents from one or more authors. For the purpose of this description and for the sake of clarity, the terms micro-contents and articles may be used interchangeably.

The micro-content database 106 is used to store the micro-contents 104 and meta-data associated with each of the micro-contents 104. The meta-data may include, but are not limited to, author of the micro-contents 104, tags or keywords associated with the micro-contents 104, date of uploading/publishing of the micro-contents 104, and genre of the micro-contents 104 and access count of the micro-contents 104. For example, a micro-content related to sports, say an article related to Soccer, can be uploaded and stored in the micro-content database 106, and thereby meta-data like Soccer, FIFA, author name, keywords and date can be associated and stored with that article to enable easy searching of that micro-content.

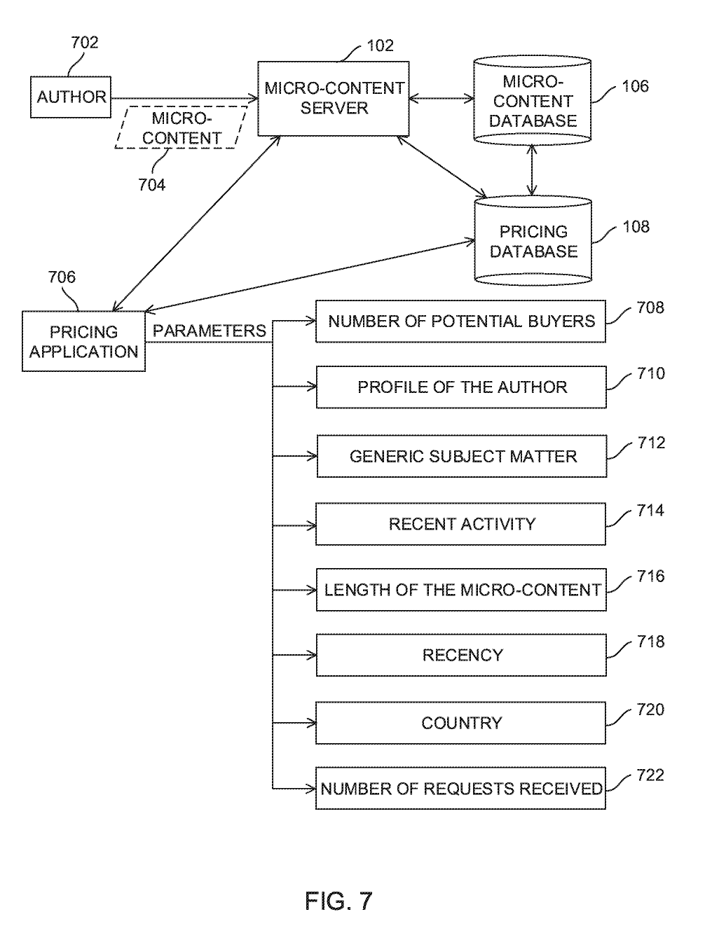

The micro-content server 102 is further associated with a pricing database 108. The pricing database 108 may include price associated with each micro-content of the micro-contents 104. In an embodiment, the price associated with each micro-content is determined using a predefined criteria. In another embodiment, the price associated with each micro-content varies dynamically. The pricing of the micro-contents 104 is further explained with reference to FIG. 7.

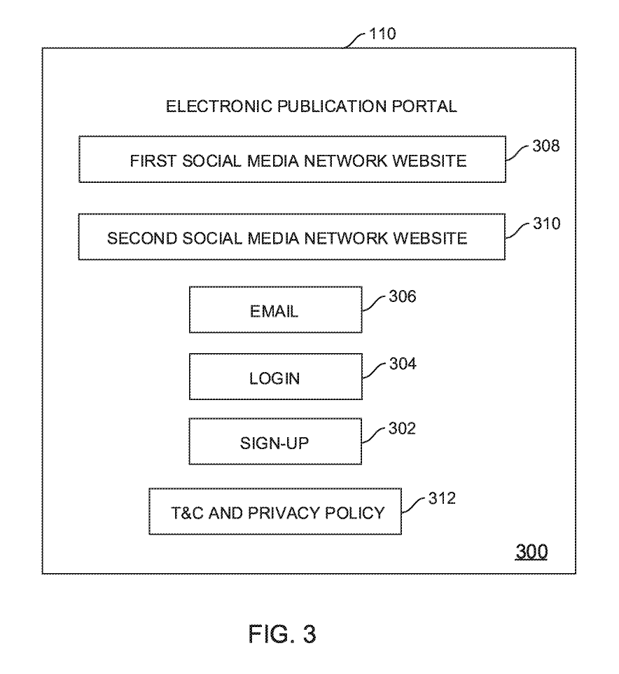

The micro-content server 102 is also associated with an electronic publication portal 110. The electronic publication portal 110 enables users, for example a user 112, to search and access the stored micro-contents in the micro-content database 106. In an embodiment, the user 112 is allowed to access the micro-contents 104 after entering his/her login account information (subscription information) on the electronic publication portal 110. In an embodiment, the electronic publication portal 110 could be a mobile based application (App) or a generic desktop based portal. The login account information could be a login account associated with the user 112 on a social media network or a unique login account associated with the electronic publication portal 110. Hence, the user 112 can either use the login account information of the social media networking website or the login account associated with the electronic publication portal 110 to access the micro-contents 104. For the sake of clarity, the login page is explained with reference to FIG. 3.

The electronic publication portal 110 is also associated with a user profile database 114. The user profile database 114 may include users profile information, preferences, transaction details, search history, users account information, and the like. In an embodiment, the electronic publication portal 110 personalizes interfaces for different users based on their profile information by providing general or customized tables of contents for electronic publications in accordance with preferences expressed or derived from the users. In an embodiment, the preferences of the user 112 may be derived from the information posted by the user 112 on a social media networking website or the information provided by the user 112 while creating an account on the electronic publication portal 110. In another embodiment, the expressed preference is entered by the user 112 explicitly while searching one or more micro-contents on the electronic publication portal 110.

Thus, the electronic publication portal 110 arranges and presents the micro-contents 104 on the electronic publication portal 110 based on each user preference. Hence, each user after entering login information may have a different and personalized view of the micro-contents 104 based on his/her preference. Therefore, a table of contents and a portal preview of one user may be different from other users. The electronic publication portal 110 also displays a cost for accessing each micro-content. In an embodiment, the cost could be extracted from the pricing database 108. The electronic publication portal 110 allows the user 112 to view the micro-contents 104 and access cost (price) associated with each of the micro-contents 104. In another embodiment, the electronic publication portal 110 may be configured to provide options for arranging, configuring and indexing the micro-contents 104, to one or more external editors linked with the electronic publication portal 110.

The user 112 may then select one or more micro-contents and pay for the selected micro-contents to access the selected micro-contents post successful payment. To enable the payments, the electronic publication portal 110 is associated with a payment server 116. In an embodiment, the selected micro-contents can be accessed online or offline. In another embodiment, the selected micro-contents can delivered to the user 112 as a web page, a PDF, or in any other format to their email ID. In an embodiment, a link to the selected micro-contents can also be sent rather than sending the selected micro-contents itself.

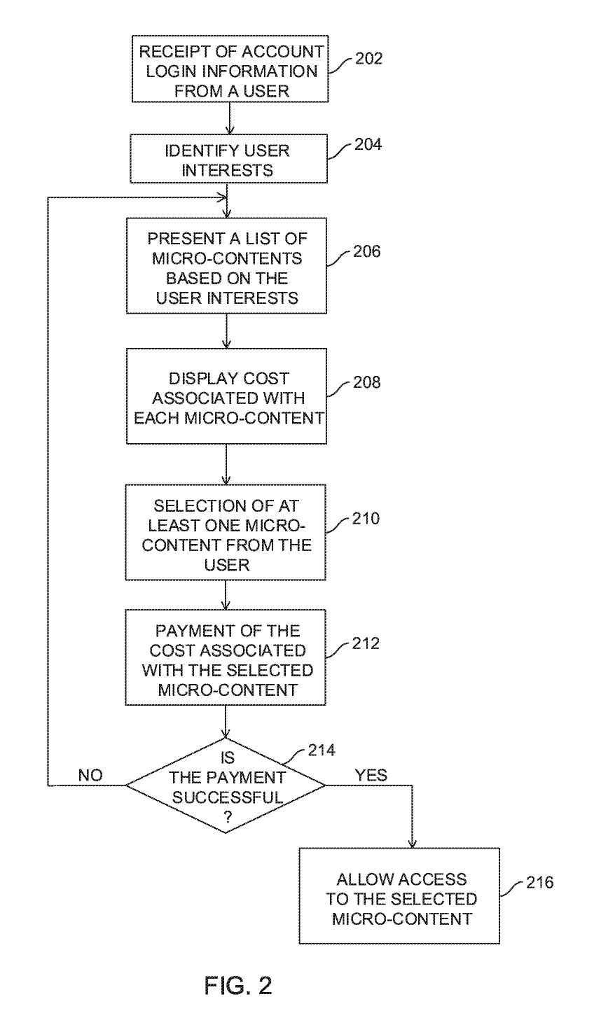

FIG. 2 is a flow chart showing an example of a method to manage micro-contents in an electronic publication, in accordance with an embodiment of the present disclosure. At step 202, login account information of a user is received, for example, the user 112 enters login account information on the electronic publication portal 110 using a login account. The login account could be either a social media networking account or a unique login account associated with the electronic publication portal 110. Example of a social media account includes, but are not limited to, Facebook™, LinkedIn™, Twitter™ and Google+™.

An exemplary representation of a user login account on the electronic publication portal 110 is shown in FIG. 3. At step 204, interests of the user are identified based on the login account information entered at step 202. For example, if the user has accessed the electronic publication portal 110 using his/her Facebook™ account, then the information posted by the user on its Facebook™ account may be analyzed to identify the user's interest. For example, if the user has liked a Facebook™ page of Soccer and Hollywood Movies and have posted information about Italian food such as Pizza. Then the user's generic interests are identified as ‘Sports’, ‘Movies’ and ‘Food’. In a refined fashion, the user's interests are identified as ‘Pizza’, ‘Soccer’ and ‘Hollywood movies’.

At step 206, a list of micro-contents is presented to the user based on the user's interest identified at step 204. As used herein, the term “list” is meant to include any representation of a plurality of micro-contents. For example, the micro-contents associated with Soccer, Food and Hollywood movies will be dynamically arranged at the starting or beginning of the electronic publication once the user login to the electronic publication portal 110. At step 208, cost (price) associated with each micro-content is also displayed in the electronic publication portal 110. In an embodiment, the cost of each article is displayed along with each micro-content in the list of micro-contents. In another embodiment, the cost is displayed when the user clicks or selects at least one micro-content in the electronic publication portal 110.

At step 210, a selection indicating at least one micro-content of the list of micro-contents is received from the user At step 212, a user is allowed to pay an accessing cost associated with the selected micro-content. In an embodiment, the payment is made through the payment server 116 (shown in FIG. 1). In an embodiment, the payment server 116 is an electronic payment gateway associated with the electronic publication portal 110. At step 214, the method checks if the user has done a successful payment. Thus, if the user has done the successful payment, then the user is allowed to access the selected micro-content at step 216. However, if the payment is unsuccessful then step 206 is performed.

FIG. 3 illustrates an exemplary depiction of a user login page 300 on the electronic publication portal 110, in accordance with an example embodiment. The user login page 300 maybe a first entry to access an electronic publication through the electronic publication portal 110. The electronic publication portal 110 or mobile application (App) associated with the electronic publication would initiate the user login page 300 when the user tries to access the electronic publication. The user login page 300 allows the user to do a registration through Sign Up tab 302 and/or allow the user to access the electronic publication through the user's portal login account using 304. The user can also optionally login through an email 306 or social media network websites, like a first social media network website account 308 or a second social media website network account 310.

Examples of social media network websites include but are not limited to Facebook™ and/or LinkedIn™. The electronic publication ‘Terms and Conditions’ (T&C) and/or Privacy Policy of the electronic publication portal 110 embedded in the link shown at 312. The T&C and/or Privacy Policy are understood to be accepted by the user if the user has signed in to the electronic publication through any login account. In an embodiment, the user will have to explicitly accept an undertaking that he/she has read and understood clearly, fully and completely the matter contained therein by signing up. Once, the login is successful, the user is presented with the table of contents of the micro-contents based on the user's interest extracted from the profile information.

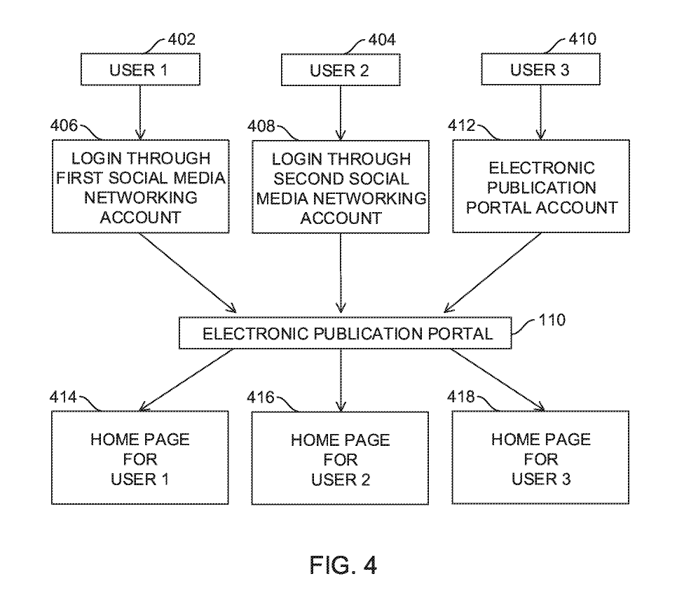

FIG. 4 illustrates an exemplary depiction of dynamically arranged cover page for multiple users, in accordance with an example embodiment. In an embodiment, the users login through the electronic publication through different login accounts. For example, a user 402 accesses the electronic publication through a first social media networking account 406, for example the user's Facebook™ account. Further, a user 404 is shown to access the electronic publication through a second social media networking account 408, for example the user's LinkedIn™ account. Furthermore, a user 410 accesses the electronic publication using an electronic publication portal login account 412.

Post login, the electronic publication cover page or home page of the electronic publication which includes the list of micro-contents is dynamically arranged for each user in a different fashion for different users based on the respective user preferences. For example, the user 402 is presented with a home page 414, the user 404 is presented with a home page 416 and similarly the user 410 is presented with a home page 418. The micro-contents on the home pages 414, 416 and 418 are arranged based on the preferences of the users 402, 404 and 410 respectively.

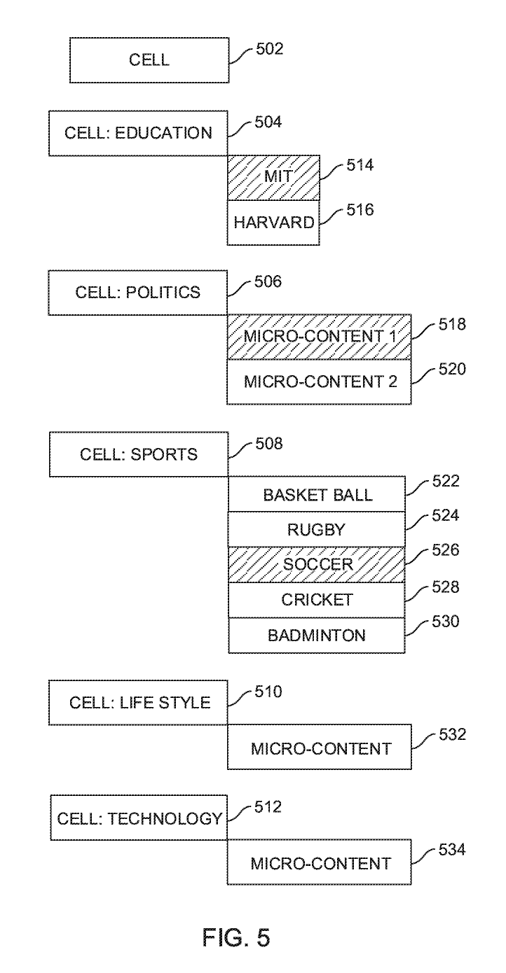

FIG. 5 illustrates an example of a template for presenting the micro-contents to users, in accordance with an example embodiment. A cell 502 provides an account name or account information of a user, for example name of the user. Cells 504, 506, 508, 510 and 512 represent micro-contents broad category, topic or genre of the micro-contents, for example, the cell 504 may represent ‘education’, the cell 506 may represent ‘politics’, the cell 508 may represent ‘sports’, the cell 510 may represent ‘lifestyle’ and the cell 512 may represent ‘technology’. In an embodiment, the topics are dynamically arranged based on the user's preference.

Each cell may include sub cells that may include a plurality of micro-contents associated with each cell. The micro-contents are the electronic articles associated with the corresponding cell category. In an embodiment, each micro-content also depicts a cost associated with the each micro-content. The cost is the cost of the micro-content which the user has to pay for accessing the micro-content. The cell 504 is shown to include sub cells 514 and 516. Therefore, if the cell 504 represents a category ‘Education’, then the sub cell 514 may include a micro-content or article associated with education, for example an article or news of ‘Massachusetts Institute of Technology’ or ‘Harvard University’ could be listed in the sub cells 514 and 516, respectively. Similarly, the cell 506 is associated with sub cells 518 and 520 and the cell 508 is associated with sub cells 522, 524, 526, 528 and 530.

In an embodiment, the sub cells are also presented or listed based on the preferences of the user. For example, if the cell 508 represents ‘Sports’ then the plurality of sub cells 522-530 may include a plurality of micro-contents associated with different sports, for example, Soccer, Cricket, Basket Ball, Rugby, Badminton and the like. Further, if the user's preference is more for Basket Ball and Rugby, then the cells including micro-content associated with Basket Ball and Rugby would be arranged higher up in the order of the list and the other sports micro-contents (articles) would be listed later. In an embodiment, the accessing cost of each micro-content is also displayed/listed with the micro-contents. Likewise, the cells 510 and 512 are associated with sub cells 532 and 534 respectively.

In an embodiment, the sub cells are displayed in a collapsible fashion under each cell. In another embodiment, the micro-contents are displayed on a separate page after clicking on the respective cells. The number of cells and sub cells in FIG. 5 are represented for the sake of clarity and illustration purpose and it nowhere limits the scope of the disclosure to the number of cells and sub cells depicted.

In an embodiment, the user is given an option to select multiple micro-contents consecutively. For example, the selected micro-contents are sub cell 514, 518 and 526, which are shaded for representation purposes. Thereafter, the user can pay collective cost associated with all the selected micro-contents and can thereby get access to the selected micro-contents.

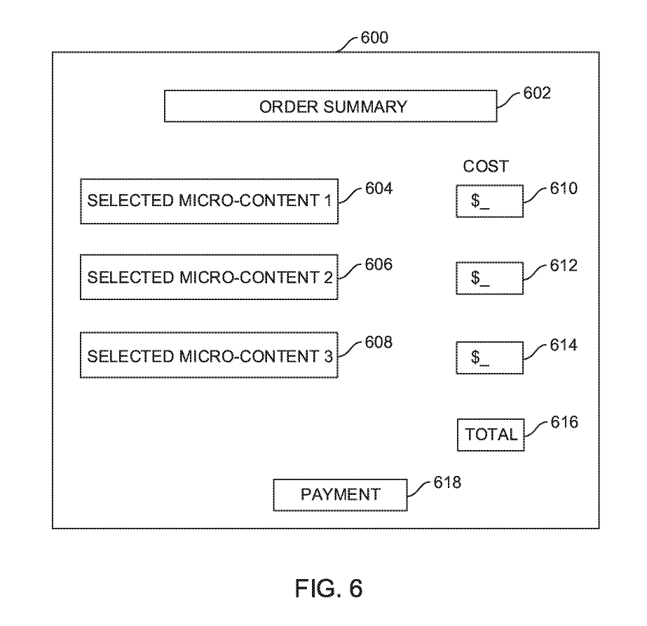

FIG. 6 illustrates an example of a template 600 for presenting the selected micro-contents and a total cost associated with the selected micro-contents, in accordance with an exemplary embodiment. The user after selecting one or more micro-contents from the electronic publication can pay the cost associated with the selected micro-contents to access the micro-contents. In an embodiment, the user after payment of the cost associated with the selected micro-contents may receive the selected micro-contents over email or is allowed to download or save the selected micro-contents on their computing devices, or may be under user account provided under the electronic publication portal 110 (e.g., any limited or unlimited storage facility provided to the user specific to his/her login account).

In the template 600, the cell 602 represents the title of the page, for example the cell 602 represents “Order Summary”. Similarly, the cells 604, 606 and 608 corresponds to some selected micro-contents (e.g., selected micro-content 1, selected micro-content 2 and selected micro-content 3) by the user from the selected sub cells 514, 518 and 526 (shown in FIG. 5), respectively. The cost for accessing each of the selected micro-contents is also listed along with the micro-content. For example, cost for accessing the micro-content mentioned in a cell 604 is represented in a cell 610. Similarly, the accessing cost of the micro-contents mentioned in the cells 606 and 608 is mentioned in cells 612 and 614, respectively.

In an embodiment, the total cost associated with all the selected micro-contents (e.g., displayed in cells 604-608) is calculated and is shown as total 616. In an embodiment, the user is also allowed to add or remove micro-contents to/from the list of selected micro-contents. The user can then pay the collective amount of all the selected micro-contents by clicking on a payment tab 618 which will take the user to the payment server 116 (shown in FIG. 1) for payment. In an embodiment, the payment of the micro-contents could be done using electronic wallet, promotional offer code, credit card, debit card, smart card or reward points.

FIG. 7 illustrates an example representation of a process for determining cost of micro-contents, in accordance with an embodiment. Consider the example of an author 702, for example a freelance journalist, submits or uploads a micro-content 704 material (herein after referred as article 704) on the micro-content server 102. The micro-content server 102 then stores the article 704 in the micro-content database 106 and simultaneously sends the article 704 to a pricing application 706.

The pricing application 706 analyses the article 704 based on information pertaining to the article 704 and a predefined criteria. Thereafter, the pricing application 706 identifies a cost associated with the article 704 and associates the cost with the article 704 and additionally store the price information in the pricing database 108. Hence, whenever a request to access the article 704 is received by a user, the price of the article 704 is fetched from the pricing database 108 and is displayed to the user for payment for accessing the article 704.

The predefined criteria to identify cost associated with the article 704 may include a number of parameters. Examples of some parameters are listed in sections 708, 710, 712, 714, 716, 718, 720 and 722. The parameters listed in section 708-722 are for example purposes only and are represented for the sake of clarity and nowhere limits the scope of invention to the listed number of parameters. Hence, the person ordinarily skilled in the art may have more or less number of parameters to identify the cost of the article.

The parameter 708 represents a criteria of identifying the cost of the article 704 based on a number of potential buyers. The pricing application 706, using the parameter 708, identifies an approximate number of buyers for the article 704 based on various factors and then determines the cost of the article 704. Examples of various factors include, but are not limited to, a number of registered users having interest in the same micro-content fields and a number of users subscribed to such micro-contents. The parameter 710 refers to a criteria of identifying a profile information of the author 702 to determine the price of the article 704. In the parameter 710, the profile information of the author 702 is analyzed to determine a number of followers of the author 702, a number of articles of the author 702 that have been published in past, popularity of the author 702, a number of different publications that the author 702 is associated with and the like. Thus, the cost of the article 704 is determined based on the profile information of the author 702.

In an embodiment, the parameter 712 provides inputs for the cost of the article 704 based on generic subject matter of the article 704. For example, the subject matter of an article associated with ‘sports’ will be assigned a higher cost than the articles associated with ‘lifestyle’. The parameter 714 identifies the cost based on recent activity associated with the article 704. For example, if the US presidential election is about to happen then the articles related to ‘politics’ could be assigned higher cost than the articles in other genre or field.

The parameter 716 determines the cost of the article 704 based on the length of the article 704, thus lengthier articles fetches higher cost than the short articles. Similarly, the section 718 determines the cost of the article based on recentness of the article 704. For example, if an article is already published on different electronic publication portals then the cost of the article could be lower than the article which is fresh and is published for the first time on the electronic publication portal 110. The parameter 720 determines the cost of the article 704 based on a country of the user (or author). For example, the cost of an article could be determined to be lower in Uganda than in the US based on the affordability of the users in particular country.

At 722, the cost could be determined based on a number of requests received by online users to access the article 704. The criteria could be used to dynamically change the cost of the article 704 if the number of online users accessing the article 704 is in large numbers and if the article 704 is sought by many users. Thus the pricing application 706 determines the cost of the article 704 based on the predefined criteria including different parameters. In an embodiment, the article 704 with cost information is store in the micro-content database 106. Thus, whenever a user request is received to access the article 704, the user may pay the cost identified and associated with the article 704 to access the article 704.

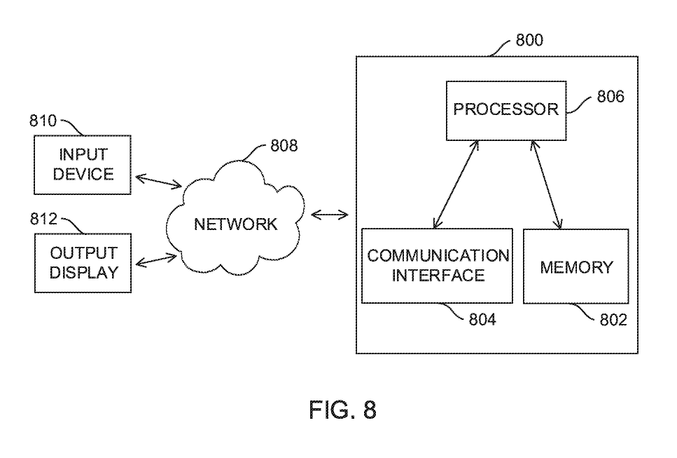

FIG. 8 illustrates a block diagram that illustrates a system 800, in accordance with an embodiment of the present disclosure. In an embodiment, the system 800 includes a memory 802, a communication interface 804 and at least one processor 806 for processing information.

The memory 802 is a storage device embodied as one or more volatile memory devices, one or more non-volatile memory devices, and/or a combination of one or more volatile memory devices and non-volatile memory devices, for storing micro-contents information and instructions. In an embodiment, the memory 802 is used to store a plurality of micro-contents. Additionally or alternatively, the memory 802 is used to store contents of various databases, like the micro-content database 106, the pricing database 108 and the user profile database 114. The memory 802 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The communication interface 804 may enable the system 800 to communicate with one or more users through a network 808. The communication interface 804 is configured to receive web requests from a user for providing accesses to at least one micro-content from the plurality of micro-contents.

The system 800 is also shown to take an input from an input device 810 of the user. In an embodiment, request received to access the micro-content is received from the input device 810 through the network 808. Examples of the input device 810 may include, but are not limited to a mobile phone, a personal computer, a laptop, a tablet device, a personal digital assistant (PDA) and the like. The system 800 further shows an output display 812, such as but not limited to a cathode ray tube (CRT), a LCD screen, a mobile device screen and a laptop screen for displaying information to the user. The system 800 sends a list of micro-contents and cost for accessing the micro-contents to be displayed on the display 812 of the user through the network 808. The communication interface 804 is capable of communicating the network 808, example of which may include but are not limited to, wired, wireless cell phone networks, Wi-Fi networks, terrestrial microwave network, or any form of Internet. While only one input device 810 and one output display 812 associated with one user is depicted in FIG. 8 for illustrative purposes, and it would be apparent that any number of input devices and output devices associated with a plurality of users coupled with the system 800 through the network 808.

The processor 806 is communicably coupled with the memory 802 and the communication interface 804. The processor 806 is capable of executing the stored machine executable instructions in the memory 802 or within the processor 806 or any storage location accessible to the processor 806. The processor 806 may be embodied in a number of different ways. In an embodiment, the processor 806 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

On receiving a user input from the input device 810 to access an electronic publication (e.g., article), the processor 806 extracts a profile information of a user from one or more databases based on login account information received from the user to access the electronic publication. The login account information could be a social media network login account or the electronic publication portal login account. The processor 806 then dynamically arranges the plurality of micro-contents in the electronic publication based on the extracted profile information of the user through which the interest of the user is identified. For example, if the processor 806 identifies that the interest of the user is in ‘sports’ and ‘education’, then the processor 806 arranges micro-contents based on the interest of the user. Therefore, the micro-contents related to ‘sports’ and ‘education’ are placed at first and second position in the electronic publication, and other micro-contents are placed at later positions.

The processor 806 then identifies cost of each of the plurality of micro-contents based on a predefined criteria. In an embodiment, the cost is identified from the pricing database 108. In an embodiment, the micro-content and cost is displayed to the user. The processor 806 is further capable of receiving request from the user to access one or more micro-contents from the plurality of micro-contents. In an embodiment, a sum of the accessing cost of the one or more micro-contents is displayed to the user. Further, the processor 806 allows the user to access the one or more micro-contents post payment of the cost of the one or more micro-contents.

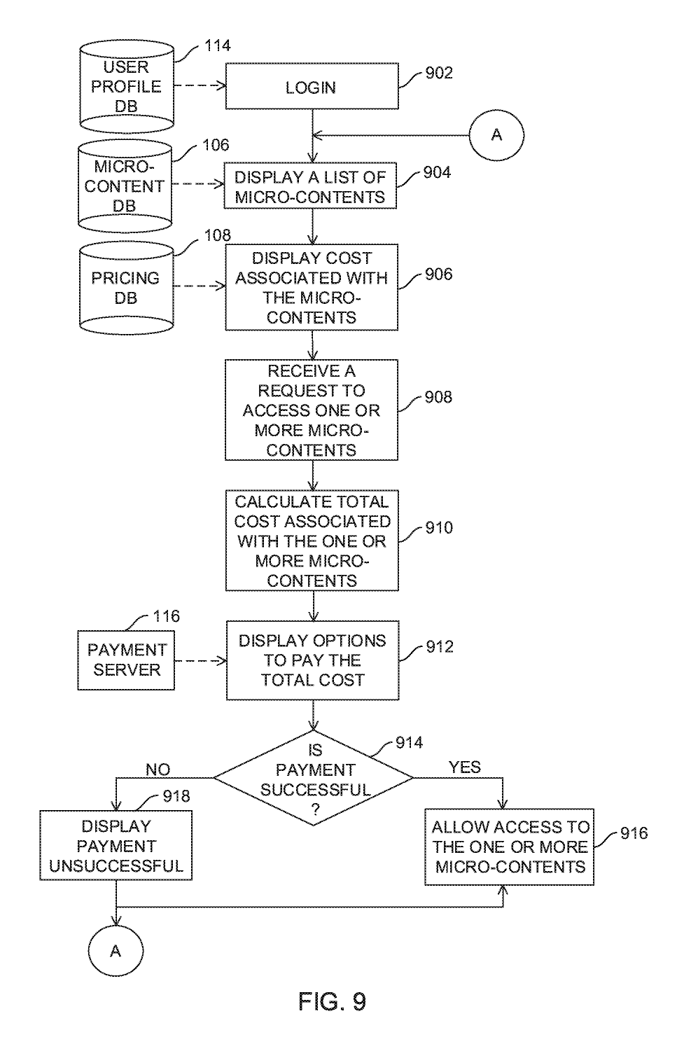

FIG. 9 illustrates a flow diagram depicting a method to manage micro-contents in electronic publications, in accordance with another example embodiment. At step 902, a user, for example the user 112 (shown in FIG. 1), login to the electronic publication portal 110 using at least one login account. The login account is depicted and explained in conjunction with FIG. 3. In an embodiment, the login account information is entered using the input device (e.g., 810) (shown in FIG. 8) associated with the user. In an embodiment, the login account could be a social media network account or an electronic publication portal login account. In an embodiment, the login account information is fetched and validated through the user profile database 114.

At step 904, a list of micro-contents is displayed on the output display 812 of the user based on the user interest. The user interest is identified by analysing the profile information of the user. The micro-contents are fetched from the micro-content database 106. At step 906, the cost associated with each micro-content is also listed along with the micro-contents. In an embodiment, the cost associated with each micro-content is fetched from a pricing database, for example the pricing database 108. In an embodiment, a free preview of each micro-content is also available and displayed for the user. The free preview enables the user to analyse the electronic micro-contents and get a gist of the micro-contents.

At step 908 a requests to access one or more micro-contents is received from the user. In an embodiment, the request to access the one or more micro-contents is received after reading an electronic preview of the one or more micro-contents. At step 910, the cost associated with accessing the one or more micro-contents is calculated. For example, if the user had selected three micro-contents and cost associated with each micro-content is $11 then the total cost to access three documents is $33.

At step 912, a user is provided (i.e., displayed) with different payment options to pay the cost identified at step 910. The different payment options for the user include, but are not limited to payment using one of an electronic wallet, a promotional offer code, a credit card, a debit card, an online banking account and reward points. In an example, if the user chooses to pay $33 calculated at step 910 using a credit card, then the payment server 116 enables the user to access the credit card bank account online through payment gateways and pay the amount through online transactions.

In another example, the user chooses the electronic wallet to pay for the selected one or more articles. The electronic wallet (E-wallet) is an online prepaid account where user can stock money, to be used when required. Hence, if the user chooses to pay the cost of the selected one or more articles through electronic wallet, then the payment server 116 checks if the user has sufficient balance in the electronic wallet account and if the user has sufficient balance then the cost associated with the one or more micro-contents is debited from the electronic wallet account. In an embodiment, the user profile information in the user profile database 114 is updated with the payment and purchase information of the one or more articles.

At step 914, the method checks if the payment is successful or not. If the payment is successful, the user is allowed to access the one or more micro-contents at step 916. In an embodiment, the user is allowed to download the one or more micro-contents on his/her computing device. In another embodiment, the one or more micro-contents are saved in the user account so that the user can access or read them in future. In an embodiment, the article is marked as purchased in the user profile database 114. Hence, the user can access the purchased one or more micro-contents in future. At step 914, if the payment is unsuccessful, a message is displayed to the user at step 918 stating that the payment was unsuccessful and the user is redirected to the step 904.

The present disclosure is described above with reference to block diagrams and flowchart illustrations of method and device embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 8. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A method for managing electronic contents in electronic publications, the method comprising:
extracting profile information of a user from one or more databases based on login account information received from the user to access an electronic publication, wherein the electronic publication includes a plurality of micro-contents;
dynamically arranging the plurality of micro-contents in the electronic publication based on the extracted profile information of the user;
identifying a cost for accessing each of the plurality of micro-contents based on a predefined criteria;
receiving a request from the user to access one or more micro-contents from the plurality of micro-contents; and
allowing the user to access the one or more micro-contents post payment of the cost for accessing the one or more micro-contents.

2. The method of claim 1, wherein the login account information is associated with a user account of the user on a social media networking website.

3. The method of claim 2, wherein extracting the profile information comprises identifying interests of the user by analysing web activity associated with the user on the social media networking website.

4. The method of claim 1, wherein the login account information is associated with a user account on an electronic publication portal hosting the electronic publication, wherein the user account on the electronic publication portal is created by the user.

5. The method of claim 4, wherein extracting the profile information comprises identifying interests of the user from at least one of: history of articles accessed by the user, interest information posted by the user on the electronic publication portal, searches performed by the user on the electronic publication portal and information selected while creating the user account on the electronic publication portal.

6. The method of claim 1, wherein the predefined criteria includes at least one of profile information of an author of a micro-content, current market trend of the micro-content, recent activity associated with contents of the micro-content, a number of requests received to access the micro-content and subject matter of the micro-content.

7. The method of claim 1, wherein the payment is made by the user from at least one of an electronic wallet, a promotional offer code, a credit card, a debit card, a smart card and reward points.

8. A system for managing electronic contents in electronic publications, the system comprising:
a memory to store an electronic publication comprising a plurality of micro-contents;
a communication interface configured to receive web requests from a user for providing accesses to at least one micro-content of the plurality of micro-contents; and
a processor communicably coupled with the memory and the communication interface, the processor configured to:
extract profile information of the user from one or more databases based on login account information received from the user to access the electronic publication;
dynamically arrange the plurality of micro-contents in the electronic publication based on the extracted profile information of the user;
identifying a cost for accessing each of the plurality of micro-contents based on a predefined criteria;
receive a request from an input device of the user to access one or more micro-contents from the plurality of micro-contents; and
allow the user to access the one or more micro-contents post payment of the cost for accessing the one or more micro-contents.

9. The system of claim 8, wherein the login account information is associated with a user account of the user on a social media networking website.

10. The system of claim 9, wherein the processor is further configured to identify interests of the user by analysing web activity associated with the user on the social media networking website.

11. The system of claim 8, wherein the login account information is associated with a user account on an electronic publication portal hosting the electronic publication, wherein the user account on the electronic publication portal is created by the user.

12. The system of claim 11, wherein the processor is further configured to extract the profile information of the user by identifying interests of the user from at least one of: history of articles accessed by the user, interest information posted by the user on the electronic publication portal, searches performed by the user on the electronic publication portal and information selected while creating the user account on the electronic publication portal.

13. The system of claim 8, wherein the predefined criteria includes at least one of profile information of an author of a micro-content, current market trend of the micro-content, recent activity associated with contents of the micro-content, a number of requests received to access the micro-content and subject matter of the micro-content.

14. The system of claim 8, further comprises a payment server that enables payment associated with accessing of the one or more micro-contents, wherein the payment is made by the user from at least one of an electronic wallet, a promotional offer code, a credit card, a debit card, a smart card and reward points.

15. A non-transitory, computer-readable storage medium storing computer-executable program instructions to implement:
extracting profile information of a user from one or more databases based on login account information received from the user to access an electronic publication, wherein the electronic publication includes a plurality of micro-contents;
dynamically arranging the plurality of micro-contents in the electronic publication based on the extracted profile information of the user;
identifying a cost for accessing each of the plurality of micro-contents based on a predefined criteria;
receiving a request from the user to access one or more micro-contents from the plurality of micro-contents; and
allowing the user to access the one or more micro-contents post payment of the cost for accessing the one or more micro-contents.

16. The medium of claim 15, wherein the login account information is associated with at least one of a user account of the user on a social media networking website and a user account on an electronic publication portal, wherein the user account on the electronic publication portal is created by the user.

17. The medium of claim 16, wherein extracting the profile information comprises identifying interests of the user by analysing web activity associated with the user on the social networking website.

18. The medium of claim 16, wherein extracting the profile information comprises identifying interests of the user from at least one of: history of articles accessed by the user, interest information posted by the user on the electronic publication portal, searches performed by the user on the electronic publication portal and information selected while creating the user account on the electronic publication portal.

19. The medium of claim 15, wherein the predefined criteria includes at least one of profile information of an author of a micro-content, current market trend of the micro-content, recent activity associated with contents of the micro-content, a number of requests received to access the micro-content and subject matter of the micro-content.

20. The medium of claim 15, wherein the payment is made by the user from at least one of an electronic wallet, a promotional offer code, a credit card, a debit card, a smart card and reward points.
